(19) United States
(12) Patent Application Publication
(10) Pub. No.: US 2022/0366094 A1
(43) Pub. Date: Nov. 17, 2022

(54) SYSTEMS AND METHODS OF VEHICLE DESIGN WITH CONTROLLED PROCESSING OF CONFIDENTIAL INFORMATION

(71) Applicant: Honda Motor Co., Ltd., Tokyo (JP)

(72) Inventors: Sayaka DELANEY, Torrance, CA (US); Makoto SEGAWA, Tochigi (JP); Takero ARIMA, Torrance, CA (US)

(21) Appl. No.: 17/319,853

(22) Filed: May 13, 2021

(51) Int. Cl. G06F 30/15

(52) U.S. Cl. CPC G06F 30/15; G06F 2111/04

(57) ABSTRACT

A method for vehicle design includes accessing a plurality of confidential documents secured by at least one access mechanism. The method also includes extracting a set of parallel data including at least one of: a vehicle feature implementing the innovative vehicle technology, a vehicle feature cost, and a vehicle feature production time, and storing each set of parallel data in a parallel data store. The method includes mapping a customer vehicle attribute to the vehicle feature in each set of parallel data by applying a customer core values model. Further, the method includes identifying potential vehicle features from the parallel data store that satisfy one or more production constraints and optimizes customer value according to the customer vehicle attributes. The method also includes generating a vehicle feature production list for the new vehicle model based on the potential vehicle features.

### BACKGROUND

Inception and production of a new vehicle model may take years of research and requires a substantial amount of money and resources. This is due in part to the highly complex design process, which requires integration of specialized expertise, research, and development in different functional areas (e.g., engineering, manufacturing, marketing, and business). Many factors must be considered and many decisions must be made that straddle these different functional areas. In typical vehicle design systems, different functional areas are not connected in a streamlined manner making it difficult to fully integrate information and efficiently make design decisions.

Additionally, it is challenging for typical vehicle design systems to integrate developing vehicle technology that often includes proprietary and/or confidential information. Because of the confidential nature of this technology, it may be siloed from the typical vehicle design systems and secured with one or more security mechanisms. The speed in which new technology is developed, which is typically much faster than the lifespan of the vehicle design process, is also an additional challenge. Along with fast technological development, predicating future customer desires and trends within the lifespan of the vehicle design process is also difficult. Customer preferences may change quickly and typical vehicle design systems do not consider these changing preferences in light of cost and production time constraints. Fully integrated and interoperable vehicle design systems may reduce vehicle development time and costs while also optimizing existing and new vehicle technology.

### BRIEF DESCRIPTION

According to one aspect, a computer-implemented method for designing a new vehicle model includes accessing a plurality of confidential documents secured by at least one access mechanism. The contents of each confidential document in the plurality of confidential documents includes innovative vehicle technology that is accessible only to authorized devices. The method also includes extracting a set of parallel data from each confidential document in the plurality of confidential documents. The set of parallel data includes at least one of: a vehicle feature implementing the innovative vehicle technology, a vehicle feature cost, and a vehicle feature production time. The method also includes storing each set of parallel data in a parallel data store. The method also includes mapping a customer vehicle attribute to the vehicle feature in each set of parallel data by applying a customer core values model. The customer vehicle attribute has a rank indicative of customer priority. The method also includes identifying potential vehicle features from the parallel data store that satisfy one or more production constraints and optimizes customer value according to the customer vehicle attributes. The method also includes generating a vehicle feature production list for the new vehicle model based on the potential vehicle features. Other embodiments of this aspect include corresponding computer systems, apparatus, and computer programs recorded on one or more computer storage devices, each configured to perform the actions of the methods.

According to another aspect, a vehicle design system includes a plurality of confidential documents secured by at least one access mechanism. The contents of each of the plurality of confidential documents includes innovative vehicle technology that is accessible only to authorized devices. The system also includes a parallel data store. The system further includes a customer core values model. The system also includes a processor operatively connected for computer communication to the parallel data store and the customer core values model, wherein the processor: accesses the plurality of confidential documents using the at least one access mechanism and extracts a set of parallel data from each confidential document in the plurality of confidential documents. The set of parallel data includes at least one of: a vehicle feature implementing the innovative vehicle technology, a vehicle feature cost, and a vehicle feature production time. The processor stores the set of parallel data from each confidential document in the parallel data store. The processor also identifies potential vehicle features from the parallel data store that satisfies one or more production constraints and optimizes customer value by mapping the vehicle feature in each set of parallel data with a customer vehicle attribute from the customer core values model. The processor also generates a vehicle feature production list for a new vehicle model based on the potential vehicle features. Other embodiments of this aspect include corresponding computer systems, apparatus, and computer programs recorded on one or more computer storage devices, each configured to perform the actions of the methods.

According to a further aspect, a non-transitory computer-readable storage medium stores computer-readable instruction for vehicle design. The instructions for vehicle design include instructions for accessing a plurality of confidential documents secured by at least one access mechanism. The contents of each of the plurality of confidential documents includes innovative vehicle technology that is accessible only to authorized devices. The instructions also include instructions for extracting a set of parallel data from each confidential document in the plurality of confidential documents. The set of parallel data includes at least one of: a vehicle feature implementing the innovative vehicle technology, a vehicle feature cost, and a vehicle feature production time. The instructions also include instructions for storing the set of parallel data from each confidential document in a parallel data store. The instructions also include instructions for mapping customer vehicle attributes to the vehicle feature in each set of parallel data by applying a customer core values model. Each of the customer vehicle attributes have a rank indicating customer priority. The instructions also include instructions for identifying potential vehicle features from the parallel data store that satisfy one or more production constraints and optimizes customer value according to the customer vehicle attributes. The instructions further include instructions for generating a vehicle feature production list for a new vehicle model based on the potential vehicle features. Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated in and constitute a part of the specification, illustrate various systems, methods, devices, and other embodiments of the disclosure. It will be appreciated that the illustrated element boundaries (e.g., boxes, groups of boxes, directional lines, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 is a block diagram of a system for vehicle design according to an exemplary embodiment;

FIG. 2 is an entity relationship diagram showing the relationship between exemplary data schemas in the system for vehicle design according to an exemplary embodiment;

FIG. 3 is a process flow diagram of a method for controlled processing of confidential documents according to an exemplary embodiment;

FIG. 4 is a process flow diagram of a method for generating and/or modifying a vehicle design according to an exemplary embodiment;

FIG. 5 is a process flow diagram for identifying vehicle features according to an exemplary embodiment; and

FIG. 6 is a data table with exemplary categories, subcategories, customer vehicle attributes, and vehicle functions according to one embodiment.

### DETAILED DESCRIPTION

The following includes definitions of selected terms employed herein. The definitions include various examples and/or forms of components that fall within the scope of a term and that may be used for implementation. The examples are not intended to be limiting. Further, the components discussed herein, may be combined, omitted or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a vehicle bus that interconnects components inside a vehicle using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more computing devices (e.g., computer, personal digital assistant, cellular telephone, network device, vehicle, vehicle computing device, infrastructure device, roadside device) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless area network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. A database may be stored, for example, at a disk and/or a memory.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Operable connection,” or a connection by which entities are “operably connected,” is one in which signals, physical communications, and/or logical communications may be sent and/or received. An operable connection may include a wireless interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets and e-readers.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle capable of carrying one or more human occupants and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) capable of carrying one or more human occupants and is powered entirely or partially by one or more electric motors powered by an electric battery. The EV may include battery electric vehicles (BEV) and plug-in hybrid electric vehicles (PHEV). The term “vehicle” may also refer to an autonomous vehicle and/or self-driving vehicle powered by any form of energy. The autonomous vehicle may carry one or more human occupants. The autonomous vehicle may have any level or mode of driving automation ranging from, for example, fully manual to fully autonomous. Further, the term “vehicle” may include vehicles that are automated or non-automated with pre-determined paths or free-moving vehicles.

### I. System Overview

As mention briefly above in the Summary, typical vehicle design system architectures are disparate and fail to integrate systems and information across different functional systems needed for efficient and purposeful vehicle design. There are no technical mechanisms to effectively analyze confidential innovative vehicle features and existing vehicle features in the context of vehicle design because confidential information is usually siloed and highly restricted within research and development systems. Furthermore, these vehicle design systems do not include technical mechanisms for quantifying customer value associated with confidential innovative vehicle features using the latest customer data. Thus, these typical vehicle design systems cannot pinpoint technologies and/or vehicle features that are most viable and in line with customer desires as well as manufacturer budget and production time constraints. This leads to long vehicle development cycles for new models requiring substantial resources and money.

Accordingly, the methods and systems described herein provide the technical solution of a system architecture for vehicle design having distributed data gathering and processing. Further, technical mechanisms for system-controlled access, processing, and up-to-date mapping of confidential information and existing vehicle features is provided in a streamlined manner. By structuring system components and processing data as described herein, a fully integrated vehicle design system is created that may optimize new vehicle technology and existing vehicle features while balancing customer value, cost, time and risk. This leads to shorter vehicle development cycles, reduced development costs, and higher customer satisfaction.

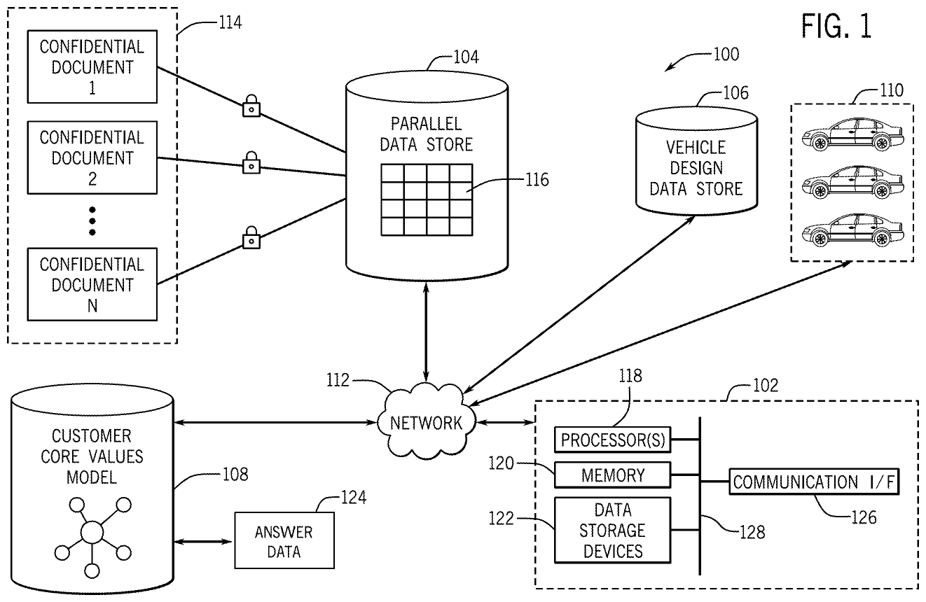

Referring now to the drawings, wherein the showings are for purposes of illustrating one or more exemplary embodiments and not for purposes of limiting same, FIG. 1 is block diagram of a vehicle design system 100 according to one exemplary embodiment. The vehicle design system 100 includes a computing device 102, a parallel data store 104, a vehicle design data store 106, a customer core values model 108, and a plurality of Original Equipment Manufacturing (OEM) vehicles 110, each operably connected for communication via a network 112. The vehicle design system 100 may be implemented by an OEM and one or more components of the vehicle design system may be distributed throughout a larger OEM computing system. It is understood that the components of the vehicle design system 100, as well as the components of other systems, hardware architectures, and software architectures discussed herein, may be combined, omitted, or organized into different architectures for various embodiments.

The computing device 102 includes processor(s) 118, a memory 120, a data storage device 122, and communication devices and interface (I/F) 126, which are each operably connected for computer communication via a bus 128 and/or other wired and wireless technologies defined herein. The computing device 102 can include provisions for processing, communicating and interacting with various components of the computing device 102 and other components of the system 100. In some embodiments, the computing device 102 may be implemented at a remote server (not shown).

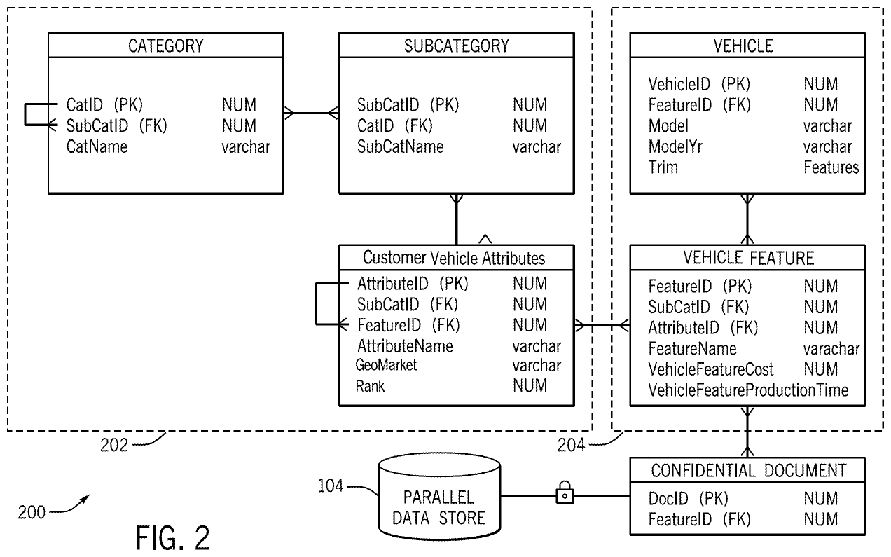

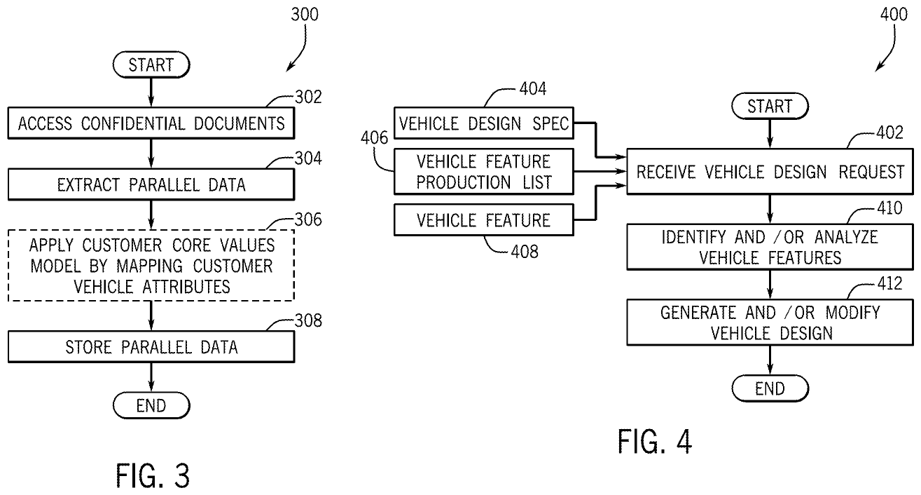

The parallel data store 104 stores data extracted from a plurality of confidential documents 114. The parallel data store 104 may include one or more databases having one or more data tables. For example, in FIG. 1, the parallel data store 104 includes a database 116 for storing structured data extracted from the plurality of confidential documents 114. The contents of the plurality of confidential documents 114 and access and extraction mechanisms will be described in further detail herein with FIGS. 2 and 3.

Referring again to FIG. 1, the system 100 includes a vehicle design data store 106 that includes manufacturer data about vehicles including design specifications for certain vehicle models, model years, trim, base model specifications, among others. Additionally, the vehicle design data store 106 may include data about existing vehicle features, new vehicle features, vehicle parts, vehicle part properties, suppliers, vehicle part costs, vehicle part and/or vehicle feature production time, and/or difficulty of implementing particular vehicle parts and/or vehicle features. Thus, the vehicle design data store 106 may include aesthetic, structural, hardware, and software details about existing and new vehicles.

The customer core values (CCV) model 108 is a data model that defines the relationship of vehicle data used in the vehicle design process with respect to the entire vehicle and customer values. The CCV model 108 is applied to the plurality of confidential documents 114 and other vehicle design data to determine vehicle design specifications that optimize customer value and vehicle technology within a set of production constraints. In some embodiments, the customer core values model 108 is a learning data model that may be trained and updated using machine learning techniques. Particulars of the structure of the CCV model 108 will be described in more detail herein with FIG. 2.

In one embodiment, the CCV model 108 may be derived from answer data 124. The answer data 124 includes customer data gather from customers using, for example, a digital survey presented to a user on a computing device (not shown). The answer data 124 may be provided by a third-party and stored at a remote server (not shown). In one embodiment, the answer data 124 includes customer data given in response to questions about customer vehicle attributes. For example, a customer may be provided with a question asking the customer to choose which customer vehicle attribute they like the most (e.g., the best) and the least (e.g., the worst). As another example, a customer is provided with a base price and asked to rank how they value different customer vehicle attributes and/or vehicle features. The customer data 124 may be specific to a certain vehicle model. In one example, the customer data 124 about a vehicle model A is used to design a new vehicle model A and/or a vehicle model B that is different from the vehicle model A.

Referring again to FIG. 1, in some embodiments, data from one or more of the plurality of OEM vehicles 110 may be used and/or accessed for real-time feedback of customer values. For example, an interface (not shown) in the one or more plurality of OEM vehicles 110 may display questions about the customer vehicle attributes as described above. The customer may provide responses as input to the interface which may then be communicated to the system 100 using, for example, the network 112. In other embodiments, vehicle data (e.g., vehicle dynamics data) stored at the plurality of OEM vehicles 110 may be accessed and/or used to modify the CCV 108 and/or the answer data 124. It is appreciated that although not shown in FIG. 1, the OEM vehicles 110 may include one or more components similar to the components of the computing device 102 and/or perform similar functions described herein with respect to the computing device 102.

Referring again to the computing device 102 of FIG. 1, the processor(s) 118 may include logic circuitry with hardware, firmware, and software architecture frameworks for facilitating vehicle design as described herein. Thus, in some embodiments, the processor(s) 118 may store application frameworks, kernels, libraries, drivers, application program interfaces, among others, to execute and control hardware and functions discussed herein. In some embodiments, the memory 120 and/or the data storage devices 122 may store similar components as the processor(s) 118 for execution by the processor(s) 118.

The communication devices and I/F 126 may include software and hardware to facilitate data input and output between the components of the computing device 102 and other components of the system 100. Specifically, the communication devices and I/F 126 may include input/output devices, network interface controllers, and other hardware and software that manages and/or monitors connections, controls bi-directional data transfer between the communication devices and I/F 126 and other components of the system 100 using, for example, the communication network 112, and controls data input and output from and to, for example, the input/output devices.

Using the system and network configuration discussed above, integrated vehicle design is implemented with controlled processing of confidential data, customer value mapping, and vehicle feature analysis. Detailed embodiments describing exemplary methods using the system and network configuration discussed above will now be discussed in detail.

### II. Data Schema Relationships for Confidential Document Processing and Mapping

Referring now to FIG. 2, an entity relationship diagram 200 illustrates relationships between data entities and fields that may be implemented with the systems and methods described herein. It is understood that in some embodiments, the entities shown in the entity relationship diagram 200 may be combined, omitted, or organized into different architectures for various embodiments. Further, one or more entities may be defined and/or stored at one or more components of the system 100.

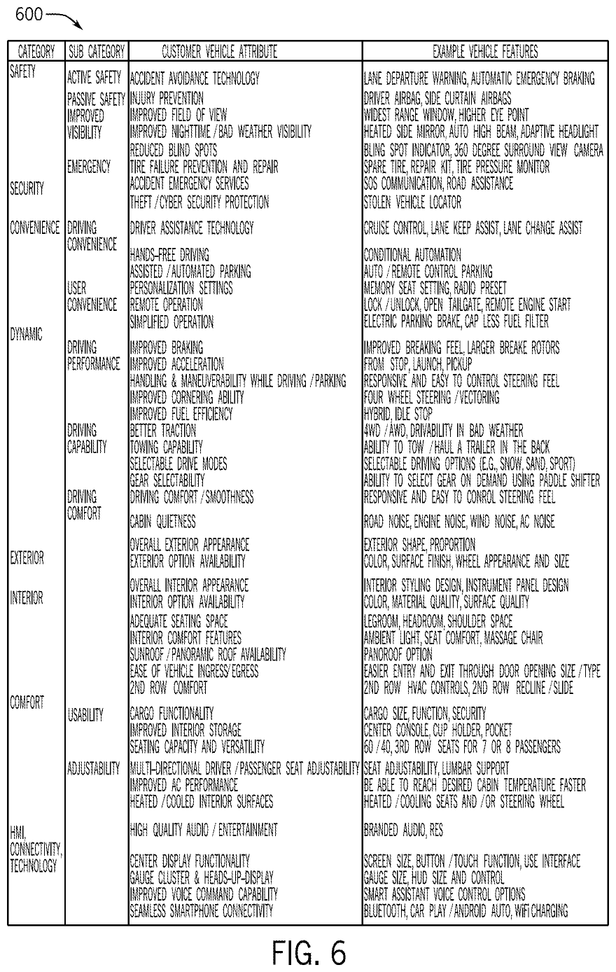

For example, a grouping 202 includes a category entity, a subcategory entity, and a customer vehicle attributes entity. The entities of the grouping 202 may be defined and/or stored within the CCV model 108. As used herein, a category and its related subcategories are characteristics of a vehicle that together describe the vehicle as a whole. An example category may be safety and include subcategories active safety, passive safety, improved visibility, and emergency. As will be described herein, customer vehicle attributes are mapped to the categories and the subcategories. Accordingly, the category safety is ultimately mapped to customer vehicle attributes and vehicle features that provide a safety function and/or feature. Other exemplary categories and subcategories are shown in the data table 600 of FIG. 6.

Referring again to FIG. 2, each entity may have one or more fields that define a property of the entity. For example, the category entity includes a unique identification field CatID and a character name field CatName. Each CatID field may have one or more related subcategories identified by the SubCatIDs field, which is a unique identification of a subcategory entity. Similarly, each SubCatID field has a character name SubCatName field.

Each subcategory may have one or more associated customer vehicle attributes. As used herein, a customer vehicle attribute describes one or more vehicle features from the customer's point of view. In some cases, this is a simplified description of the benefits of one or more vehicle features and/or a customer's emotional or factual state that drives the customer's urge to purchase (e.g., buying motivation). An example customer vehicle attribute may be injury prevention, which is mapped to the category safety and the subcategory passive safety. As another example, a customer vehicle attribute may be driver assistance technology, which is mapped to a category convenience and a subcategory driving convenience. Other exemplary customer attributes are shown in the data table 600 of FIG. 6.

In FIG. 2, the customer vehicle attribute entity has a unique identification field AttributeID, a character name field AttributeName, a geographic market identifier field GeoMarket, and a priority value field Rank. As discussed above in FIG. 1, customer vehicle attributes are derived from answer data 124. In one embodiment, the customer vehicle attributes are ranked by customer priority as determined based on the answer data 124. The Rank field is indicative of customer preference priority of the customer vehicle attribute. In one embodiment, the rank field is associated with a specific geographic region (e.g., midwest, east coast, west coast, south). Accordingly, the geographic market identifier GeoMarket may be a geographic region of customers for which the customer vehicle attribute was tested. In some embodiments discussed herein, the CCV model 108 defines a predefined number of top customer vehicle attributes based on the answer data 124. For example, based on the answer data 124, the CCV model 108 may store the top forty-five (45) customer vehicle attributes which each include a rank indicative of customer preference priority.

The customer vehicle attribute entity is also associated with one or more vehicle features, which is defined by a vehicle feature entity. A vehicle feature as used herein is a distinctive aspect or function of a vehicle that may be comprises of one or more hardware and/or software components and/or parts. In FIG. 2, the vehicle feature entity is shown in a grouping 204 with a vehicle entity. In this example, the entities in the grouping 204 may be defined and/or stored at the vehicle design data store 116. In FIG. 2, the vehicle feature entity includes a unique identification field FeatureID, associated SubCatID field and AttributeID field, a character name FeatureName field, a vehicle feature cost field VehicleFeatureCost, a vehicle feature production time field VehicleFetureProductionTime. The vehicle feature cost is a cost value of one or more components required to implement the vehicle feature. In one embodiment, the cost is derived from supplier data that may be stored at a remote server (not shown). The vehicle feature production time is a time value indicative of the time required to implemented the vehicle feature in a vehicle during production. Although not shown in FIG. 2, the vehicle feature entity may include other fields. For example, a feature difficulty field that is a value indicative of the difficulty (e.g., hard, easy) of implementing particular vehicle parts and/or vehicle features.

Referring back to the examples discussed above, an example vehicle feature may be a lane departure warning system. The lane departure warning system is mapped to the category safety, the subcategory active safety, and the customer vehicle attribute accident avoidance technology. As another example, the vehicle feature driver airbag is mapped to the category safety, the subcategory passive safety, and the customer vehicle attribute injury prevention. Other exemplary vehicle features are shown in the data table 600 of FIG. 6.

Also shown in FIG. 2 is a confidential document entity. The confidential document entity is created based on the set of parallel data extracted from one or more of the plurality of confidential documents 114 and stored at the parallel data store 104. The confidential document entity includes a unique identification field DocID. The FeatureID field identifies the vehicle feature (i.e., a vehicle feature implementing the innovative vehicle technology) disclosed in the confidential document. The FeatureID field is linked the set of parallel data including a vehicle feature cost, and a vehicle feature production time defined in the vehicle features entity. The data schema shown in FIG. 2 will now be described in more detail with mechanisms for confidential document processing and mapping.

### III. Confidential Document Processing and Mapping

Referring now to FIG. 3, a process flow diagram of a method 300 for controlled processing of confidential documents according to an exemplary embodiment is shown. FIG. 3 will be described with reference to FIGS. 1 and 2. At block 302, the method 300 includes accessing confidential documents. As shown in FIG. 1, the plurality of confidential documents 114 are each secured by at least one access mechanism represented by the lock symbols. Accessibility to each confidential document by an access mechanism includes the selective restriction of access to the confidential document using, for example, login credentials and/or other security mechanisms. The login credentials and/or other security mechanisms could be stored or input at, for example, the computing device 102. In some embodiments, each confidential document may have a unique access mechanism each requiring a different login credential. For example, each confidential document in the plurality of confidential documents 114 could each be stored at different servers having different access mechanisms.

The content of each confidential document in the plurality of confidential documents 114 includes innovative vehicle technology that is accessible only to authorized devices and/or users. For example, this content may include invention disclosure materials associated with new vehicle technology. In some embodiments, the content may include materials with subject matter that is patent protected and/or for which patent protection is currently being sought. The plurality of confidential documents 114 may also include undisclosed design specifications for new and/or existing vehicle technology. In some cases, the plurality of confidential documents 114 may include other types of documents that may not be directly tied to innovative technology, for example, contracts, confidentially agreements, and so on. Thus, in one embodiment, at block 302 the method 300 may include identifying documents in the plurality of confidential documents 114 when the contents of the documents include innovative vehicle technology that is accessible only to the authorized devices. In this scenario, data is extracted and stored (as described below) only from documents identified by the processor(s) 108 as having innovative vehicle technology that is accessible only to the authorized devices.

At block 304 the method 300 includes extracting parallel data from the plurality of confidential documents 114. For example, the processor(s) 118 may extract data as a set of defined structured data (e.g., a set of parallel data) from each confidential document in the plurality of confidential documents 114. In one embodiment, the set of parallel data includes at least one of: a vehicle feature implementing the innovative vehicle technology, a vehicle feature cost, and a vehicle feature production time. As will be discussed herein, the set of parallel data is stored in the parallel data store 104, for example, in the database 116.

In one embodiment, the set of parallel data represents the innovative vehicle technology while still maintaining the confidential nature of the data. Thus, the parallel data store 104 is a parallel corpus to the plurality of confidential documents 114. For example, the set of parallel data includes the unique identifier field DocID which is an ambiguous identifier tied to the original confidential document (e.g., in the plurality of confidential documents 114). The vehicle feature implementing the innovative vehicle technology in the set of parallel data refers to the vehicle feature with an ambiguous identifier (i.e., FeatureID) so that specific details of the innovative vehicle technology maintain confidentiality. Accordingly, proprietary information remains safe and may still be used as a consideration in the vehicle design process.

Referring again to the method 300, at block 306, the method 300 includes applying the CCV model 108. More specifically, the processor(s) 118 apply the CCV model 108 to the confidential document and/or the set of parallel data to map a customer vehicle attribute to the vehicle feature described in the confidential document of the plurality of confidential documents 114. The customer vehicle attribute has a rank (i.e., Rank field) indicative of customer priority. In some embodiments, the set of parallel data includes the rank associated with customer priority and a modified geographic rank (i.e., GeoMarket field) associated with customer priority from a geographic market constraint.

At block 308, the method 300 includes storing the set of parallel data from each confidential document in the plurality of confidential documents 114 in the parallel data store 104. As described above, the customer vehicle attribute and the rank are derived from answer data 124 that indicates preferred vehicle functionality. In one embodiment, at block 308, the processor(s) may monitor for a change in the answer data 124. Upon determining a change in the answer data 124, the processor(s) 108 may update the mapping of the customer vehicle attribute, the rank, and the vehicle feature in each set of parallel data. This ensures that the most up-to-date customer preferences are utilized in the vehicle design process.

### IV. Selecting Vehicle Features to Optimize Technology and Customer Value

Vehicle design methodologies may be applied to the systems and data structures described above, including the parallel data store 104 representing confidential information, to select vehicle features to be implemented in a vehicle that optimize vehicle technology, customer preferences, cost, and production constraints. Referring now to FIG. 4 a method 400 for generating a vehicle design specification according to the vehicle design system 100 is shown. Initially it is noted that the process flow described herein with the method 400 is flexible enough to adapt to different vehicle design inputs for generating, analyzing, and/or modifying a list of vehicle features to be implemented in a vehicle. For example, at block 402, the method 400 includes receiving a vehicle design request, which may include a vehicle design specification 404 including base vehicle features and production constraints. For example, the vehicle design specification 404 could be a vehicle design specification for a previous year model to be modified for a new year model. In other embodiments, the vehicle design request includes a vehicle feature production list 406. The vehicle feature production list could include vehicle features implemented in a previous year model to be analyzed and/or modified for a new year model with specific production constraints. The vehicle production list 406 could also include “a wish list” of vehicle features for a new vehicle model to be analyzed and/or modified. In another example, a specific vehicle feature may be included in the vehicle design request to be analyzed and determine whether the vehicle feature should be added and/or removed from a vehicle feature production list. The flexibility provided by the mechanism allows for efficient use of vehicle design data with “plug-n-play” modifications based on new vehicle features and up-to-date customer value data. Accordingly, these methods pinpoint technologies and/or vehicle features that are most viable and in line with customer desires as well as manufacturer budget and production time constraints.

Referring again to block 402 of the method 400, in some embodiment the vehicle design request is a new vehicle mode request for a new vehicle model. The vehicle design request and/or the new vehicle model request includes a base vehicle features list and the one or more production constraints. In some embodiments, the base vehicle features list is a list of vehicle features from a previous year vehicle model. The one or more production constraints include a total cost constraint and a total production time constraint.

At block 410, the method 400 includes identifying and/or analyzing vehicle features. For example, the processor(s) 118 may identify potential vehicle features from the vehicle features stored in the parallel data store that satisfy one or more production constraints and optimize customer value according to the customer vehicle attributes defined by the CCV model 108.

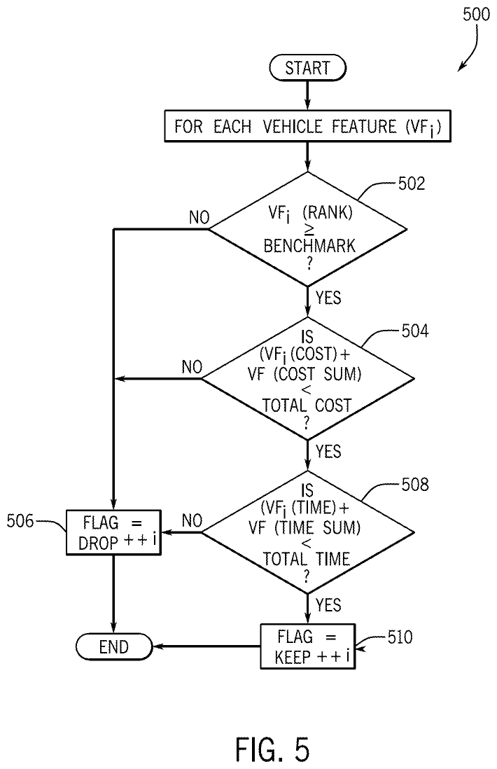

At block 412, the method 400 includes generating and/or modifying the vehicle design specification based on the potential vehicle features identified at block 410. For example, the processor(s) 118 may generate a vehicle feature production list by modifying the base vehicle features list based on the potential vehicle features. This may include suggesting one or more of the potential vehicle features be added to the base vehicle features list. This may also include suggesting removing a vehicle feature in the base vehicle features list. Blocks 410 and 412 will now be described in more detail with FIG. 5.

Referring now to FIG. 5, a method 500 for identifying and/or analyzing vehicle features is shown. In this example, a set of vehicle features VFi are analyzed. Depending on the design input at block 402 of FIG. 4, the set of vehicle features VFi may include vehicle features from the plurality of confidential documents 114 and stored at the parallel data store 104, existing vehicle features, and/or wishlist vehicle features. In one embodiment, the processor(s) 108 identifies potential vehicle features from the parallel data store 104 that satisfies one or more production constraints and optimizes customer value by mapping the vehicle feature in each set. The vehicle feature production list may then be generated based on the potential vehicle features. Accordingly, For each vehicle feature VFi, at block 502, the method 500 includes comparing a rank associated with a vehicle feature with a predefined benchmark. Upon determining the rank of the vehicle feature is greater than or equal to the predetermined benchmark, the method 500 continues to block 504. If at block 502, it is determined that the rank of the vehicle feature is less than the predetermined benchmark, the method 500 proceeds to block 506, where the vehicle feature is removed from the vehicle feature production list. More specifically, at block 506, a flag for the vehicle feature is set to DROP. Accordingly, at block 412 of the method 400, the vehicle features with a flag set to DROP are not included with the generated vehicle feature production list. Alternatively, the vehicle features with a flag set to DROP are identified as suggested vehicle features to remove from the vehicle feature production list.

Referring again to FIG. 5, at block 504, the method 500 includes comparing the cost associated with the vehicle feature VFi with the total cost constraint. More specifically, a total cost sum of all vehicle features is maintained. The processor(s) 118 add the cost associated with the specific vehicle feature VFi to the total cost sum and compares the total cost sum to the total cost production constraint. If the cost satisfies (e.g., is less than) the total cost production constraint, the method 500 proceeds to block 508. Otherwise, the method 500 proceeds to block 506.

At block 508, the method 500 includes comparing the production time associated with the vehicle feature with the total production time constraint. Similar to block 504, a total time sum of all vehicle features is maintained. The cost associated with the specific vehicle feature VFi is added to the total time sum and compared to the total cost constraint. If the total time sum satisfies the total cost constraint, the method 500 proceeds to block 510. Otherwise, the method 500 proceeds to block 506. At block 510, the vehicle feature is added to the vehicle feature production list. More specifically, at block 510, a flag for the vehicle feature VFi is set to ADD. Accordingly, at block 412 of the method 400, the vehicle features with a flag set to ADD are added and/or included with the generated vehicle feature production list. Alternatively, the vehicle features with a flag set to ADD are identified as suggested vehicle features to add to the vehicle feature production list. This process of analyzing vehicle features with up-to-date customer value data and confidential information allows the system 100 to pinpoint technologies and/or vehicle features that are most viable and in line with customer desires as well as manufacturer budget and production time constraints.

The embodiments discussed herein may also be described and implemented in the context of “computer-readable medium” or “computer storage medium.” As used herein, “computer-readable medium” or “computer storage medium refers to a non-transitory medium that stores instructions, algorithms, and/or data configured to perform one or more of the disclosed functions when executed. Computer-readable medium may be non-volatile, volatile, removable, and non-removable, media implemented in any method or technology for storage of information such as computer readable instructions, data structures, modules or other data. Computer-readable medium may include, but is not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device may interface with. Computer-readable medium excludes non-transitory tangible media and propagated data signals.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for designing a new vehicle model, comprising:
accessing a plurality of confidential documents secured by at least one access mechanism, wherein contents of each confidential document in the plurality of confidential documents includes innovative vehicle technology that is accessible only to authorized devices;
extracting a set of parallel data from each confidential document in the plurality of confidential documents, wherein the set of parallel data includes at least one of: a vehicle feature implementing the innovative vehicle technology, a vehicle feature cost, and a vehicle feature production time;
storing the set of parallel data from each confidential document in the plurality of confidential documents in a parallel data store;
mapping a customer vehicle attribute to the vehicle feature in each set of parallel data by applying a customer core values model, wherein the customer vehicle attribute has a rank indicative of customer priority;
identifying potential vehicle features from the parallel data store that satisfy one or more production constraints and optimizes customer value according to the customer vehicle attributes; and
generating a vehicle feature production list for the new vehicle model based on the potential vehicle features.

2. The computer-implemented method of claim 1, further including receiving a new vehicle model request, wherein the new vehicle model request includes a base vehicle features list and the one or more production constraints.

3. The computer-implemented method of claim 2, wherein generating the vehicle feature production list includes modifying the base vehicle features list based on the potential vehicle features.

4. The computer-implemented method of claim 1, wherein the one or more production constraints include a total cost constraint and a total production time constraint.

5. The computer-implemented method of claim 1, wherein upon determining the rank of the vehicle feature is greater than or equal to a predetermined benchmark, adding the vehicle feature to the vehicle production list.

6. The computer-implemented method of claim 5, upon determining the rank of the of the vehicle feature than the predetermined benchmark, removing the vehicle feature from the vehicle production list.

7. The computer-implemented method of claim 1, wherein the set of parallel data includes the rank associated with customer priority and a modified geographic rank associated with customer priority from a geographic market constraint.

8. The computer-implemented method of claim 1, further including identifying documents in the plurality of confidential documents when the contents of the documents include the innovative vehicle technology that is accessible only to the authorized devices and extracting the set of parallel data includes extracting the set of parallel data from the identified documents.

9. The computer-implemented method of claim 1, wherein the customer vehicle attribute and the rank are derived from answer data from customers that indicate preferred vehicle functionality, and upon determining a change in the answer data, updating the mapping of the vehicle feature in each set of parallel data.

10. The computer-implemented method of claim 1, wherein the customer vehicle attribute and the rank associated with the customer vehicle attribute quantifies customer preferences for existing technology and new technology for an entire vehicle a whole.

11. A vehicle design system, comprising:
a plurality of confidential documents secured by at least one access mechanism, wherein the contents of each of the plurality of confidential documents includes innovative vehicle technology that is accessible only to authorized devices;
a parallel data store;
a customer core values model; and
a processor operatively connected for computer communication to the parallel data store and the customer core values model, wherein the processor:
accesses the plurality of confidential documents using the at least one access mechanism;
extracts a set of parallel data from each confidential document in the plurality of confidential documents, wherein the set of parallel data includes at least one of: a vehicle feature implementing the innovative vehicle technology, a vehicle feature cost, and a vehicle feature production time;
stores the set of parallel data from each confidential document in the parallel data store;
identifies potential vehicle features from the parallel data store that satisfies one or more production constraints and optimizes customer value by mapping the vehicle feature in each set of parallel data with a customer vehicle attribute from the customer core values model; and
generates a vehicle feature production list for a new vehicle model based on the potential vehicle features.

12. The vehicle design system of claim 11, wherein the customer vehicle attribute indicates a vehicle functionality and the customer vehicle attributes has a rank, wherein the customer vehicle attribute and the rank are derived from answer data from customers that indicate preferred vehicle functionality.

13. The vehicle design system of claim 12, wherein upon determining a change in the answer data, the processor updates the mapping of the vehicle feature in each set of parallel data and the processor identifies the potential vehicle features based on the updated mapping.

14. The vehicle design system of claim 12, wherein the processor further identifies the potential vehicle features by analyzing each vehicle feature in the parallel data store with the customer core values model to determine the potential vehicle features that optimize the rank of the customer vehicle attribute associated with each vehicle feature given the vehicle feature cost and the vehicle feature production time.

15. The vehicle design system of claim 12, wherein the processor further identifies the potential vehicle features by comparing the rank of the vehicle feature in each set of parallel data to a predetermined benchmark, and the processor generates the vehicle production list based on the comparison.

16. A non-transitory computer-readable storage medium storing computer-readable instructions, comprising:
instructions for accessing a plurality of confidential documents secured by at least one access mechanism, wherein the contents of each of the plurality of confidential documents includes innovative vehicle technology that is accessible only to authorized devices;
instructions for extracting a set of parallel data from each confidential document in the plurality of confidential documents, wherein the set of parallel data includes at least one of: a vehicle feature implementing the innovative vehicle technology, a vehicle feature cost, and a vehicle feature production time;
instructions for storing the set of parallel data from each confidential document in a parallel data store;
instructions for mapping customer vehicle attributes to the vehicle feature in each set of parallel data by applying a customer core values model, wherein each of the customer vehicle attributes have a rank indicative of customer priority;
instructions for identifying potential vehicle features from the parallel data store that satisfy one or more production constraints and optimizes customer value according to the customer vehicle attributes; and
instructions for generating a vehicle feature production list for a new vehicle model based on the potential vehicle features.

17. The non-transitory computer-readable storage medium of claim 16, wherein the instructions for identifying the potential vehicle features includes instructions to add the vehicle feature to the vehicle production list if the rank of the vehicle feature is greater than or equal to a predetermined benchmark.

18. The non-transitory computer-readable storage medium of claim 17, wherein the instructions for identifying the potential vehicle features includes instructions to remove the vehicle feature from the vehicle production list if the rank of the vehicle feature is less than the predetermined benchmark.

19. The non-transitory computer-readable storage medium of claim 16, wherein the customer vehicle attribute and the rank are derived from answer data from customers that indicate preferred vehicle functionality, and the instructions further includes updating the mapping of the vehicle feature in each set of parallel data upon determining a change in the answer data.

20. The non-transitory computer-readable storage medium of claim 16, wherein the instructions for generating the vehicle feature production list include instructions for modifying a base vehicle features list of a previous vehicle model based on the potential vehicle features.
